(19) United States
(12) Patent Application Publication
(10) Pub. No.: US 2015/0263790 A1
(43) Pub. Date: Sep. 17, 2015

(54) Near Field Communication (NFC) Objects and Cloud Infrastructure to Improve Application Distribution and Engagement

(71) Applicant: Jason Shih-Shen Chein, Bellevue, WA (US)

(72) Inventor: Jason Shih-Shen Chein, Bellevue, WA (US)

(21) Appl. No.: 14/645,149

(22) Filed: Mar. 11, 2015

Related U.S. Application Data
(60) Provisional application No. 61/953,651, filed on Mar. 14, 2014.

(51) Int. Cl. H04B 5/00; H04W 4/00; H04W 76/02

(52) U.S. Cl. CPC H04B 5/0031; H04W 76/023; H04W 4/008

(57) ABSTRACT

A method and system for controlling an NFC device are provided, the NFC device comprising an NFC module for establishing an NFC connection with an NFC chip, and a network module for establishing a network connection with a cloud infrastructure, the method comprising: establishing an NFC connection between the NFC chip and the NFC device; receiving a unique reference identification (URI) of the NFC chip by an app configured to process the URI; establishing a network connection between the app and the cloud infrastructure; transmitting the URI to the cloud infrastructure; receiving NFC data associated with the URI from the cloud infrastructure; and executing the app in accordance with the NFC data.

### CROSS-REFERENCE TO RELATED APPLICATIONS

This application claims the benefit and priority of U.S. Provisional Patent Application No. 61/953,651, entitled “Field communication (NFC) and cloud infrastructure (Service) to improve application (App) distribution and engagement,” filed on Mar. 14, 2014. The entire disclosures of the above application are incorporated herein by reference.

### TECHNICAL FIELD

The present invention relates to computer and communication technologies, and more particularly, to near field communication (NFC) objects and cloud infrastructure to improve application distribution and engagement.

### BACKGROUND

The term “app” is a shortening of the term “application software”, and an app is a computer program designed to run on smartphones, tablet computers and other mobile devices.

Mobile apps were originally offered for general productivity and information retrieval, including email, calendar, contacts, stock market and weather information. However, public demand and the availability of developer tools drove rapid expansion into other categories, such as social media, picture sharing, mobile games, factory automation, GPS mapping and location-based services, banking, video streaming, shopping and payment apps.

The popularity of mobile apps has continued to rise, as their usage has become increasingly prevalent across mobile phone users. Consequently, it is becoming increasingly important for app developers to effective distribute their apps. Apps are usually available for downloading through application distribution platforms, which began appearing in 2008 and are typically operated by the owner of the mobile operating system, such as the Apple App Store, Google Play, Windows Phone Store, and BlackBerry App World. Usually, the users are directed to the platforms through a link to a particular app, but the users can also search for a particular app on the platform.

As discussed above, apps are typically downloaded electronically from application distribution platforms, and therefore any app discovery is limited to what the platforms expose to their users. Other app discoveries are done through mobile advertisement. While some app discoveries are being pushed to traditional media such as TV advertisement, few discovery mechanics are associated with anything tangible. And for those tied to tangible objects such as a poster or a business card, their implementations are often cumbersome and do not improve user engagement with the apps. However, a human being has a natural desire for tangible things, as people tend to value something that they can see and touch much more than something they cannot, especially if the tangible things offer continuous value through the apps. Therefore, there is a need for a method and system for application distribution and engagement using tangible objects.

Near field communication (NFC) is a set of wireless technologies that enables smartphones and other NFC devices to establish radio communication with each other by touching them together or bringing them into proximity, typically a distance of 10 cm (3.9 in) or less. NFC standards cover communications protocols and data exchange formats, and are based on existing radio-frequency identification (RFID) standards including ISO/IEC 14443 and FeliCa. The standards include ISO/IEC 18092 and those defined by the NFC Forum.

### SUMMARY OF THE INVENTION

Embodiments of the present invention provide a method and apparatus for using near field communication (NFC) objects and cloud infrastructure to improve application distribution and engagement by speeding up user acquisition through physical objects and by using data associate with these physical objects to deliver value-added services.

In accordance with one embodiment of the present invention, a method of controlling an NFC device is provided, the NFC device comprising an NFC module for establishing an NFC connection with an NFC chip, and a network module for establishing a network connection with a cloud infrastructure, the method comprising: establishing an NFC connection between the NFC chip and the NFC device; receiving a unique reference identification (URI) of the NFC chip by an app configured to process the URI; establishing a network connection between the app and the cloud infrastructure; transmitting the URI to the cloud infrastructure; receiving NFC data associated with the URI from the cloud infrastructure; and executing the app in accordance with the NFC data.

In accordance with another embodiment of the present invention, an NFC system is provided, comprising an NFC object comprising an NFC chip comprising a unique reference identification (URI); a cloud infrastructure comprising a database for storing NFC data associated with the URI; and an NFC device comprising an NFC module for establishing an NFC connection with the NFC chip; a network module for establishing a network connection with the cloud infrastructure; and an app embedded with an with an application programming interface (API) for connecting to the cloud infrastructure; wherein the app is configured to, upon receiving the URI of the NFC chip, receive NFC data associated with the URI from the cloud infrastructure.

In accordance with yet another embodiment of the present invention, an NFC device is provided, comprising an NFC module for establishing an NFC connection with an NFC chip; a network module for establishing a network connection with a cloud infrastructure; and an app embedded with an application programming interface (API) for connecting to the cloud infrastructure; wherein the app is configured to, upon receiving a unique reference identification (URI) of the NFC chip, receive NFC data associated with the URI from the cloud infrastructure.

In accordance with yet another embodiment of the present invention, an NFC object for installing and controlling an app on an NFC device is provided, the NFC object is embedded with an NFC tag comprising an NFC chip comprising a unique reference identification (URI) and an embedded command to prompt a user to install an app embedded with an application programming interface (API) for connecting to an cloud infrastructure, wherein the app is configured to receive NFC data associated with the URI from the cloud infrastructure; and an antenna configured to establish NFC communication between the NFC chip and the NFC device; wherein upon receiving the unique reference identification (URI) through the antenna, the NFC device is configured to, if the app is not installed, execute the embedded command to prompt a user to install the app, and to execute the app in accordance with the NFC data received from the cloud infrastructure.

In accordance with yet another embodiment of the present invention, the method comprises verifying the URI by the cloud infrastructure.

In accordance with yet another embodiment of the present invention, the method comprises sending updated NFC data to the cloud infrastructure; and update the NFC data by the cloud infrastructure.

In accordance with yet another embodiment of the present invention, the app is embedded with an application programming interface (API) for connecting to the cloud infrastructure.

In accordance with yet another embodiment of the present invention, the app is a gaming app, and the URI is associated with a game object.

By embedding app information within NFC chips and inside physical forms (NFC Objects), new users can be acquired through the distribution of these NFC Objects. In combination with the provided cloud infrastructure (Service) and software development kit (SDK), value-added services in the apps can be delivered using data associated with each NFC Object stored on the Service (NFC Data). Additionally, NFC Objects serve as offline reminders for users to engage with the App continuously. Accordingly, embodiments of the present invention enhance user acquisition and engagement by associating digital benefits with physical objects.

### BRIEF DESCRIPTION OF THE DRAWINGS

To better illustrate the technical features of the embodiments of the present invention, various embodiments of the present invention will be briefly described in conjunction with the accompanying drawings. It is obvious that the drawings are but for exemplary embodiments of the present invention, and that a person of ordinary skill in the art may derive additional drawings without deviating from the principles of the present invention.

FIG. 1 is an exemplary schematic diagram for an NFC object for installing and controlling an app on an NFC device in accordance with embodiments of the present invention.

FIG. 2 is an exemplary schematic diagram for an NFC device in accordance with embodiments of the present invention.

FIG. 3 is an exemplary schematic diagram for a cloud infrastructure in accordance with embodiments of the present invention.

FIG. 4 is an exemplary schematic diagram for an NFC system in accordance with embodiments of the present invention.

FIG. 5 is an exemplary flowchart for a method for controlling an NFC device in accordance with an embodiment of the present invention.

FIG. 6 is an exemplary schematic diagram for an NFC system adopted for a gaming app in accordance with embodiments of the present invention.

### DESCRIPTION OF THE PREFERRED EMBODIMENTS

To better illustrate the purpose, technical feature, and advantages of the embodiments of the present invention, various embodiments of the present invention will be further described in conjunction with the accompanying drawings.

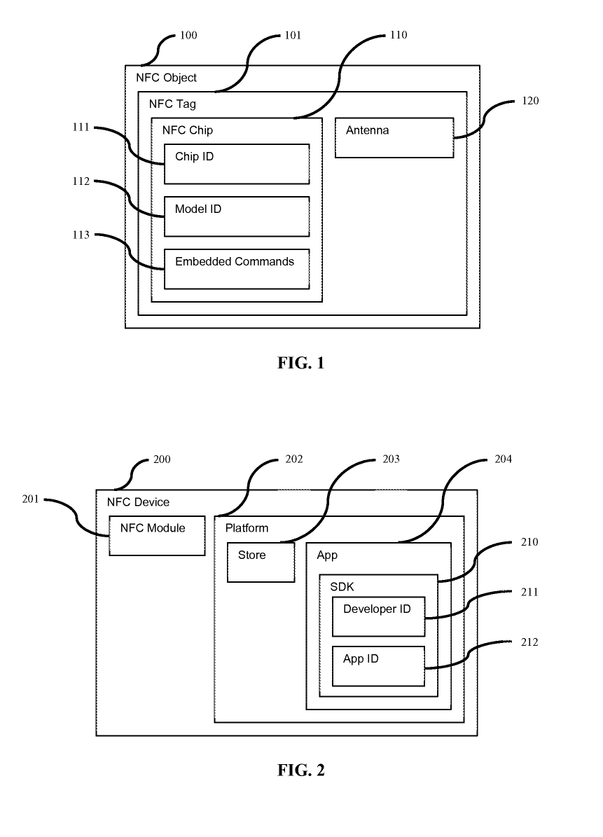

FIG. 1 is an exemplary schematic diagram for an NFC object for installing and controlling an app on an NFC device in accordance with embodiments of the present invention.

As shown in FIG. 1, the NFC Object 100 is a physical item (i.e. product, packaging, card, token, etc.) with a NFC Tag 101. The NFC Tag 101 consists of a NFC Chip 110 (i.e. NXP NTAG203) and an Antenna 120. The NFC Chip 110 contains a Chip ID 111, a Model ID 112, and Embedded Commands 113.

The Chip ID 111 is a serial number configured by chip manufacturer at time of fabrication. The Model ID 112 is a reference code configured by chip manufacturer at time of fabrication. The Embedded Commands 113 are configured by App developers during the manufacturing process of NFC Objects; specific commands is determined by targeted Platform(s) the NFC Object is configured to support. The NFC Object 100 can be uniquely identified by a unique reference identification (URI), which can be or can be derived from the Chip ID 111, the Model ID 112, or the Embedded Commands 113 of the NFC Chip 110. While the Chip ID 111 itself is sufficient to form the URI, the inclusion of the Model ID 112 and the Embedded Commands 113 makes the system more secure. Antenna 120 operates at 13.56 MHz radio frequency and is used to power NFC Chip and transmit information on NFC Chip to NFC Device.

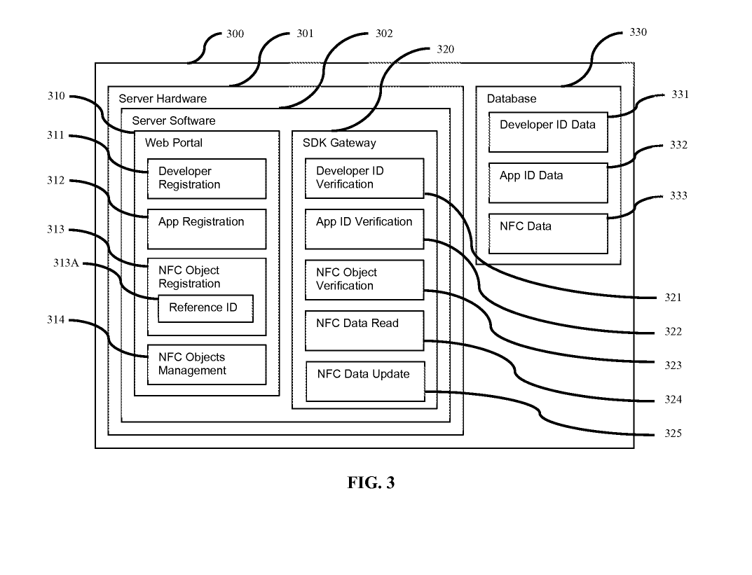

FIG. 2 is an exemplary schematic diagram for an NFC device in accordance with embodiments of the present invention.

As shown in FIG. 2, the NFC Device 200 can be a mobile phone or a tablet fitted with NFC sensor (i.e. Samsung Galaxy S3 and Google Nexus 7) or a laptop or desktop computer fitted with NFC peripheral. The NFC Module 201 is the hardware sensor or peripheral that broadcasts radio waves at 13.56 MHz frequency and retrieves information stored on NFC Chips. Platform 202 is the operating system (i.e. Android) on the NFC Device 200 that serves as the gateway between the NFC Module 201 and client software.

Store 203 is the App distribution channel on the Platform.

App 204 is client software built by third party developers to run on the Platform.

SDK 210 is a software development kit provided to App developers and embedded as part of their Apps; it serves as the gateway between the App 204, the Platform 202, and the Service. SDK 210 contains a group of application programming interfaces (API) that enable the App 204 to interact with the Platform 202 and the Service.

Developer ID 211 is generated by the Service for each App developer; it is used to verify the App developer is a registered developer with rights to access the Service.

App ID 212 is generated by the Service for each App; it is linked to Developer ID and is used to verify the App has rights to a NFC Object's NFC Data on the Service.

FIG. 3 is an exemplary schematic diagram for a cloud infrastructure in accordance with embodiments of the present invention.

As shown in FIG. 3, the Service 300 is a cloud infrastructure made out of Server Hardware 301, Server Software 302, and Databases 330 that manages data records and business logic related to App developers, Apps, and NFC Objects.

Server Hardware 301 is the computational hardware that handles communications and hosts Server Software that handles business logic.

Server Software 302 has a Web Portal access point and a SDK access point; each access point contains software modules for specific purposes.

Web Portal 310 is used by App developers to register access to the Service and to generate and manage records of their Apps and NFC Objects. Web Portal 310 can be replaced by a Developer Portal to handle functions that are not web-based.

Developer Registration 311 is the software module that verifies the App developer and generates Developer ID.

App Registration 312 is the software module that generates App ID and links it to the Developer ID.

NFC Objects Registration 313 is the software module that creates an associated NFC Data record in the Database for each NFC Object; this module also links the NFC Object to the App ID.

Reference ID 313A is used to link NFC Object and its NFC Data in the Database; it is a unique and non-sequential number associated with URI of the NFC Chip.

NFC Objects Management 314 is the software module for App developer to configure database tables for each NFC Object's NFC Data in the Database.

SDK Gateway 320 is used by the App-embedded SDK or App server-embedded SDK to interface with the Service; SDK will submit Developer ID, App ID, Chip ID, Model ID, and intended commands to the SDK Gateway for processing.

Developer ID Verification 321 is the software module that verifies the identity and access rights of the App developer.

App ID Verification 322 is the software module that verifies the App and its association with Developer ID.

NFC Objects Verification 323 is the software that derives Reference ID from Chip ID and Model ID of the NFC Chip and verifies that the Reference ID is associated with the App ID.

NFC Data Read 324 is a software module that retrieves NFC Data associated with a NFC Object using its Reference ID from the Database.

NFC Data Update 325 is a software module that updates NFC Data associated with a NFC Object using its Reference ID in the Database.

Database 330 is the storage that saves information related to App developers, Apps, NFC Objects, and their relationships.

Developer ID Data 331 is the data record containing information on the App developers (i.e. name, contact information, etc.).

App ID Data 332 is the data record containing information on Apps, their App developers, and NFC Objects they control (i.e. name, version, etc.).

NFC Data 333 is the data record of each NFC Object, linked by Reference ID, and contains both system information (i.e. creation date, last accessed by, App ID association, etc.) and custom data tables configured by their App Developers using NFC Objects Management.

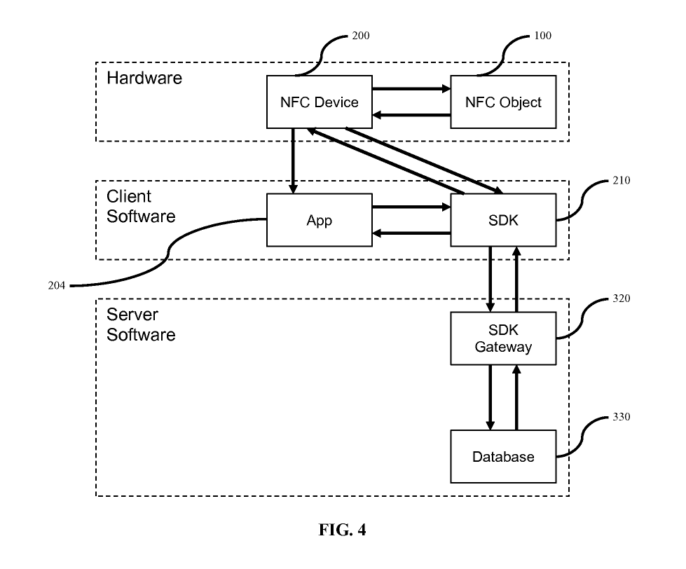

FIG. 4 is an exemplary schematic diagram for an NFC system in accordance with embodiments of the present invention.

As shown in FIG. 4, the NFC system includes the following hardware: an NFC object NFC Object 100, and NFC Device 200, and Server Hardware (not shown). Client Software includes App 204, and SKD 210. Server Software includes SDK Gateway 320 and Database 330. FIG. 4 further illustrates interactions between various components under normal operation to launch an installed App 204 using a NFC Object 100 and to read NFC Data of that NFC Object from the Service.

When a NFC Device 200 comes in contact with a NFC Object 100, radio wave generated by its NFC Module is received by NFC Tag's Antenna to power the NFC Chip. The NFC Chip in turn transmits its information, including Chip ID, Model ID, and Embedded Commands to the NFC Module through the Antenna. Then the Platform parses out Embedded Commands and executes them. An example of Embedded Commands is to launch a specific App. If the App 204 is installed on the NFC Device 200, the Platform launches the App 204 as intended. If the App 204 is not installed on the NFC Device 200, the Platform launches the Store for the user to download the App 204. Detailed support of this functionality is based on specific Platform and its version number (i.e. Android 4.0 or later).

Once the App is launched, the App initiates embedded SDK 210, which requests Chip ID and Model ID from the Platform. When the App requests to read or update NFC Data related to the NFC Object 200, the SDK 210 submits Chip ID, Model ID, Developer ID, App ID, and intended command to the SDK Gateway 320 on the Service. The SDK's connectivity to the SDK Gateway can happen at the App level or at the App's server level for added security.

When the SDK Gateway 320 receives information from SDK 210, it first verifies if the Developer ID is valid against the Developer ID Data in the Database. If so, it then verifies if the App ID is valid against the App ID Data in the Database. It also verifies if the App ID is associated with the Developer ID. If so, it then derives Reference ID from Chip ID and Model ID and verifies if the Reference ID is associated with the App ID using NFC Data in the Database. Note that a Reference ID can be associated with multiple App IDs and allow sharing of NFC Data and NFC Objects between these Apps. Lastly, SDK Gateway 320 executes the command through either Read NFC Data or Update NFC Data and returns its result to the SDK, which is passed onto the App.

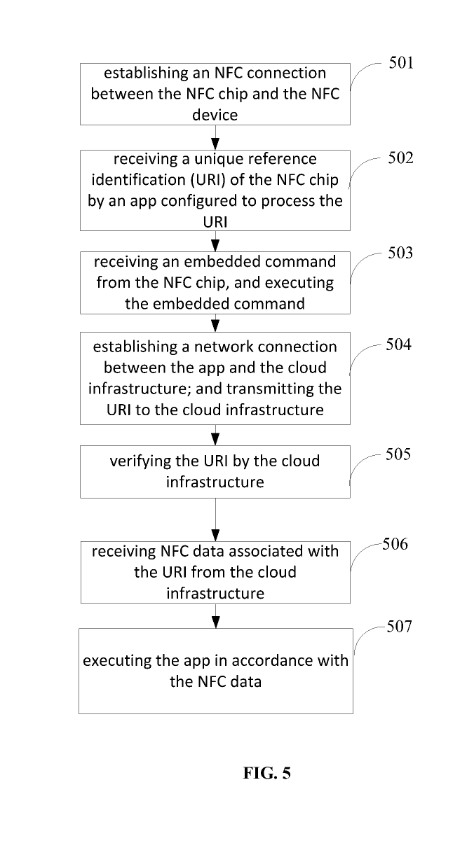

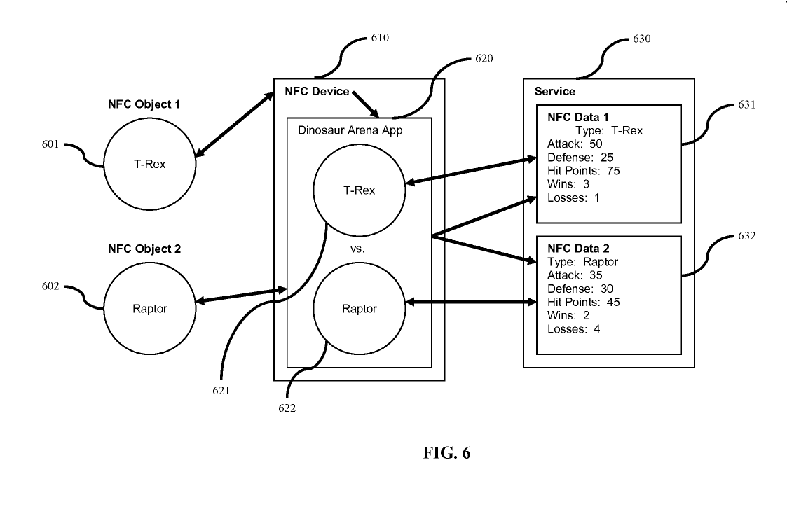

FIG. 5 is an exemplary flowchart for a method for controlling an NFC device in accordance with an embodiment of the present invention. As shown in FIG. 5, the method comprises the following steps.

Step 501, establishing an NFC connection between the NFC chip and the NFC device: NFC Device comes in contact with NFC Object, its NFC Module powers the NFC Chip through the Antenna.

Step 502, receiving a unique reference identification (URI) of the NFC chip by an app configured to process the URI: NFC Object transmits Chip ID, Model ID, and Embedded Commands to NFC Device's Platform through the Antenna and the NFC Module.

Step 503: receiving an embedded command from the NFC chip, and executing the embedded command: Platform executes Embedded Commands and launches specified App. App initiates NFC Data Read request to the SDK with its Developer ID and App ID. SDK requests Chip ID and Model ID from the Platform. Platform returns Chip ID and Model ID Chip to the SDK. The Embedded Commands can also be sent from the Platform to increase security.

Step 504, establishing a network connection between the app and the cloud infrastructure; and transmitting the URI to the cloud infrastructure: SDK submits NFC Data Read request to the SDK Gateway with Developer ID, App ID, Chip ID and Model ID.

Step 505, verifying the URI by the cloud infrastructure: SDK Gateway verifies Developer ID using Developer ID Verification, verifies App ID and its relationship to the App developer using App ID Verification, derives Reference ID from Chip ID and Model ID, verifies Reference ID and its relationship to the App using NFC Objects Verification, and send read request to the Database through NFC Data Read. Database returns NFC Data to the SDK Gateway.

Step 506, receiving NFC data associated with the URI from the cloud infrastructure: SDK Gateway returns NFC Data to the SDK.

Step 507, executing the app in accordance with the NFC data. SDK returns NFC Data to the App, and the App executes accordingly.

Each NFC Object is a user acquisition and engagement tool. When a NFC-enabled device (NFC Device) touches a NFC Object, it will launch the App that is specified by the NFC Object. If the App is not installed on the device, user will be prompted to install it from available storefronts for the device. Thus acquires a new user or re-engages a dormant user for the developer. If the App is installed on the device, the App uses the SDK to submit request to the Service and receives NFC Data to enable any value-added services associated with the NFC Object. App can further update NFC Data on the Service using the SDK.

The embodiments of the present invention provides the following advantages: Speed—NFC Objects send commands to NFC Devices by physical contact and do not require users to launch a separate App such as scanner to access its content; Predictable—NFC Objects are manufactured at a pre-determined unit price whereas banner ads operate on auction and per-view, per-click, or per-install basis; Cost Efficient—With support of cloud infrastructure, NFC Objects require minimal memory storage on NFC Chips and therefore reduce overall manufacturing costs; Durable—NFC Objects remain an effective tool for acquiring and engaging users as long as it is able to transmit data to NFC Devices; Expandable—Each NFC Object has its own NFC Data on the Service and total memory footprint is not bound by memory storage limitation on the NFC Chip itself; Accessible—Developers can retrieve and update each NFC Data record on the Service through the SDK as needed; Accurate—Each NFC Object is uniquely identified to track its effectiveness in acquiring new users and engaging existing users; Customizable—Each NFC Object has its own NFC Data on the Service and can be modified to deliver a specific digital benefit without impacting other NFC Objects; and Private—Only the NFC Object and its registered App and App developer can retrieve its NFC Data from the Service.

The embodiments of the present invention have a wide application ranging from one-time user acquisition to long-term user engagement. It also serves a wide range of App categories from games, education to social network. Here are a couple of examples.

Game developer creates NFC Objects representing game characters inside their game App. By distributing these NFC Objects to users, the developer entices users to try their game App. When a user interacts with the NFC Object, the user will gain access to the game character represented by the NFC Object. As the user progresses through the game and improves this game character, changes are recorded in the NFC Object's NFC Data on the Service. The user can later give the NFC Object to another user, and the new user can discover the game App by interacting with the NFC Object. The new user will also gain access to the game character and the NFC Data on the Service.

In accordance with embodiments of the present invention, the Service centrally manages the NFC data associated with the NFC Objects, and can easily implement many useful functionalities. For example, if an NFC Object representing a game character is stolen, the Service can easily disable that NFC Object so that it can no longer be used. The Service can also associate an NFC object with a specific NFC device or a specific app, and only allow that NFC device or app to be activated by the NFC object. Furthermore, the Service can enable the finders keepers concept, where a device or an app will lose access to an NFC object if that NFC object has been associated with another device or app.

FIG. 6 is an exemplary schematic diagram for an NFC system adopted for a gaming app in accordance with embodiments of the present invention. As shown in FIG. 6, the NFC system includes two NFC objects 601 and 602, an NFC device 610 installed with a gaming App, Dinosaur Arena App 620, which has two game characters T-Rex 621 and Raptor 622, and Service 630 containing NFC data 631 and 632.

FIG. 6 illustrates an example use case where the game, Dinosaur Arena 620, uses NFC Objects 601 and 602 to represent dinosaur characters 621 and 622 and uses the Service 630 to store and manage NFC Data 631 and 632.

First, NFC Device 610 interacts with NFC Object 601, which is labeled as a T-Rex dinosaur character for the Dinosaur Arena App 620, and obtains its Chip ID, Model ID, and Embedded Commands.

NFC Device 610 launches Dinosaur Arena App 620 per Embedded Commands.

Dinosaur Arena App 620 obtains NFC Data 631 from the Service through the SDK using Chip ID, Model ID, Embedded Commands, Developer ID and App ID; NFC Data 631 indicates to App 620 that NFC Object 601 is a T-Rex 621 character and provides value to all of its attributes (i.e. attack, defense, etc.)

While Dinosaur Arena App 620 is still running, NFC Device 610 interacts with NFC Object 602, which is labeled as a Raptor dinosaur character, and obtains its Chip ID and Model ID.

Dinosaur Arena App 620 obtains NFC Data 632 from the Service through the SDK; NFC Data 632 indicates to App 620 that NFC Object 602 is a Raptor 622 character and provides value of all of its attributes.

Dinosaur Arena App 620 then simulates a battle between T-Rex 621 (NFC Object 601) and Raptor 622 (NFC Object 602) using their respective attributes, determines T-Rex 621 is the winner, and updates the win and loss attribute of NFC Data 631 and NFC Data 632 on the Service through the SDK.

While NFC objects represent game characters in a gaming app in this embodiment, they can also be easily configured to represent other game objects, such as weapons that game characters use.

Note that a Reference ID can be associated with multiple App IDs and allow sharing of NFC Data between these Apps. Additionally, each App ID can have its own NFC Data that is unique to the App. Therefore the same NFC Object can have multiple attributes where some are shared across multiple Apps while others are unique only to a specific App.

In accordance with an embodiment of the present inventions, the NFC Object is a toy of a Triceratops dinosaur. Inside the Dinosaur Arena App, this particular Triceratops, uniquely identified by its Reference ID, has a User-Defined Name of “Three Horn Hero” and Attack Rating of “80”. Inside the Dinosaur Safari App, the same Triceratops shares the same User-Defined Name of “Three Horn Hero” and Diet of “Herbivore”. Both Dinosaur Arena App and Dinosaur Safari App can change the User-Defined Name. At the same time, each App has its own unique data that is relevant to its functionality.

In accordance with an embodiment of the present inventions, the NFC Objects can be made removable for portability and mobility. For example, instead of embedding the NFC Chip inside a toy, it is embedded inside a token, which is then inserted into the base of the action figure. By doing so, users benefit from the small form factor of tokens as well as receiving the offline play value of toys.

In accordance with an embodiment of the present invention suitable for the entertainment industry, developer creates NFC Objects as media tokens. Different NFC Objects represents a different movie, TV episode, music album, photo album, etc. When a user interacts with the NFC Object using with the NFC Device, the NFC Object launches the App and loads or streams content based on its NFC Data. For example, a media token can represent the digital rights to stream a particular episode from a children's cartoon series. For young children who cannot easily navigate through text menus to find their favorite episode, they can simply interact with the NFC Object to steam it. App developer can later change the attributes of the NFC Objects and provide relevant services. For example, a movie token will play a preview clip of an upcoming movie, instead of the preview clip that was associated with the token when it was manufactured a year ago.

In accordance with another embodiment of the present invention, a social App developer creates NFC Objects as wedding invitation for couples to distribute among friends and families. When friends and families interact with NFC Objects, they discover the App, which allows them to RSVP for the wedding. Before the wedding, friends and families can interact with NFC Objects to bring up the gift registry. After the wedding, friends and families can interact with NFC Objects to view and share wedding photos. Years after the wedding, friends and families can interact with NFC Objects to view and share family moments and milestones such as birth of a child.

In accordance with an embodiment of the present invention suitable for social media, developer creates NFC Objects for a specific event such as a music concert or a sports game. These NFC Objects are then distributed to attendees at the event. When a user interacts with his/her NFC Object, he/she is instantly connected to a real time social network of other users that have interacted with their NFC Objects. These users can chat, share photos, and obtain additional event information during and after the event. If a user has a photo taken by the event organizer, the photo can be made available to the user by associating it with the user's NFC Object.

The various modules, units, and components described above can be implemented as an Application Specific Integrated Circuit (ASIC); an electronic circuit; a combinational logic circuit; a field programmable gate array (FPGA); a processor (shared, dedicated, or group) that executes code; or other suitable hardware components that provide the described functionality. The processor can be a microprocessor provided by from Intel, or a mainframe computer provided by IBM.

Note that one or more of the functions described above can be performed by software or firmware stored in memory and executed by a processor, or stored in program storage and executed by a processor. The software or firmware can also be stored and/or transported within any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any medium that can contain or store the program for use by or in connection with the instruction execution system, apparatus, or device. The computer readable medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The various embodiments of the present invention are merely preferred embodiments, and are not intended to limit the scope of the present invention, which includes any modification, equivalent, or improvement that does not depart from the spirit and principles of the present invention.

1. A method of controlling an NFC device, the NFC device comprising an NFC module for establishing an NFC connection with an NFC chip, and a network module for establishing a network connection with a cloud infrastructure, the method comprising:
establishing an NFC connection between the NFC chip and the NFC device;
receiving a unique reference identification (URI) of the NFC chip by an app configured to process the URI;
establishing a network connection between the app and the cloud infrastructure;
transmitting the URI to the cloud infrastructure;
receiving NFC data associated with the URI from the cloud infrastructure; and
executing the app in accordance with the NFC data.

2. The method of claim 1, further comprising:
verifying the URI by the cloud infrastructure.

3. The method of claim 1, further comprising:
sending updated NFC data to the cloud infrastructure; and
update the NFC data by the cloud infrastructure.

4. The method of claim 1, further comprising:
receiving an embedded command from the NFC chip; and
executing the embedded command.

5. The method of claim 1, wherein the app is embedded with an application programming interface (API) for connecting to the cloud infrastructure.

6. The method of claim 5, wherein the app is a gaming app, and the URI is associated with a game object, and the method further comprising:
executing the gaming app to interact with the game object.

7. The method of claim 5,
removably embedding the NFC chip in an NFC object.

8. The method of claim 5, wherein the NFC data is associated with a digital resource, and the method further comprising:
executing the app to access the digital resource.

9. The method of claim 1, further comprising if the app is not installed on the NFC device, receiving an embedded command from the NFC chip to prompt a user to install the app to the NFC device.

10. The NFC system of claim 9, wherein the embedded command comprises a universal resource locator (URL).

11. An NFC system comprising
an NFC object comprising an NFC chip comprising a unique reference identification (URI);
a cloud infrastructure comprising a database for storing NFC data associated with the URI; and
an NFC device comprising
an NFC module for establishing an NFC connection with the NFC chip;
a network module for establishing a network connection with the cloud infrastructure; and
an app embedded with an with an application programming interface (API) for connecting to the cloud infrastructure;
wherein the app is configured to, upon receiving the URI of the NFC chip, receive NFC data associated with the URI from the cloud infrastructure.

12. The NFC system of claim 11, wherein the cloud infrastructure is configured to verify the URI.

13. The NFC system of claim 11, wherein the app is further configured to send updated NFC data to the cloud infrastructure; and the cloud infrastructure is configured to update the NFC data in accordance with the updated NFC data.

14. The NFC system of claim 11, wherein the NFC device is configured to receive an embedded command from the NFC object, and execute the embedded command.

15. The NFC system of claim 11, wherein the app is embedded with an application programming interface (API) for connecting to the cloud infrastructure.

16. The NFC system of claim 15, wherein the app is a gaming app, and the URI is associated with a game object.

17. The NFC system of claim 15, wherein the NFC chip is removably embedded in the NFC object.

18. The NFC system of claim 15, wherein the NFC data is associated with a digital resource, and the app is configured to access the digital resource.

19. The NFC system of claim 15, wherein the NFC chip comprises an embedded command to prompt a user to install the app to the NFC device.

20. The NFC system of claim 19, wherein the embedded command comprises a universal resource locator (URL).

21. An NFC device, comprising
an NFC module for establishing an NFC connection with an NFC chip;
a network module for establishing a network connection with a cloud infrastructure; and
an app embedded with an with an application programming interface (API) for connecting to the cloud infrastructure;
wherein the app is configured to, upon receiving a unique reference identification (URI) of the NFC chip, receive NFC data associated with the URI from the cloud infrastructure.

22. The NFC device of claim 21, wherein the app is further configured to send updated NFC data to the cloud infrastructure.

23. The NFC device of claim 21, wherein the NFC device is further configured to receive an embedded command from the NFC chip, and execute the embedded command in accordance with the NFC data.

24. The NFC device of claim 21, wherein the app is embedded with an application programming interface (API) for connecting to the cloud infrastructure.

25. The NFC device of claim 24, wherein the app is a gaming app, and the URI is associated with a game object.

26. An NFC object for installing and controlling an app on an NFC device, the NFC object is embedded with an NFC tag comprising
an NFC chip comprising a unique reference identification (URI) and an embedded command to prompt a user to install an app embedded with an application programming interface (API) for connecting to an cloud infrastructure, wherein the app is configured to receive NFC data associated with the URI from the cloud infrastructure; and
an antenna configured to establish NFC communication between the NFC chip and the NFC device;
wherein upon receiving the unique reference identification (URI) through the antenna, the NFC device is configured to, if the app is not installed, execute the embedded command to prompt the user to install the app, and to execute the app in accordance with the NFC data received from the cloud infrastructure.

27. The NFC object of claim 26, wherein the app is a gaming app, and the URI is associated with a game object.

28. The NFC object of claim 26, wherein the NFC chip is removably embedded in the NFC object.
